(19) United States
(12) Patent Application Publication
(10) Pub. No.: US 2016/0144538 A1
(43) Pub. Date: May 26, 2016

(54) BIOMIMETIC ADHESIVE LAYER AND METHOD OF MANUFACTURING THE SAME

(71) Applicant: NATIONAL TSING HUA UNIVERSITY, Hsinchu (TW)

(72) Inventors: Cheng-Kuo Sung, Hsinchu (TW); Chih-Yi Hung, Hsinchu (TW)

(21) Appl. No.: 14/618,851

(22) Filed: Feb. 10, 2015

(30) Foreign Application Priority Data
Nov. 20, 2014 (TW) 103140225

(51) Int. Cl. B29C 43/02; C09J 11/04

(52) U.S. Cl. CPC B29C 43/02; C09J 11/04; B29L 2007/00

(57) ABSTRACT

A biomimetic adhesive layer is provided, and has a plurality of protrusions with a bottom surface and an upper surface of each of the protrusions; and a support portion connecting with the bottom surface. The protrusions are formed by a polymeric material mixed with permeance particles. Moreover, a method of manufacturing a biomimetic adhesive layer is provided, and has the steps of: providing a metallic mold having a plurality of filling apertures; compressing a polymer substrate with the metallic mold to fill the polymer substrate within the apertures; curing the polymer substrate; and separating the metallic mold from the polymer substrate to obtain the biomimetic adhesive layer.

### CROSS REFERENCE TO RELATED APPLICATIONS

This application claims the priority benefit from Taiwan Patent Application No. 103140225, filed on Nov. 20, 2014, the disclosure of which is incorporated herein by reference.

### FIELD OF THE INVENTION

The present invention relates to a biomimetic adhesive layer and a method of manufacturing the biomimetic adhesive layer, and more particularly to a biomimetic adhesive layer capable of controlling the adhesive direction and a method of manufacturing the same.

### BACKGROUND OF THE INVENTION

Currently, the electronics industry has evolved from traditional solid-state electronic components into flexible electronic components. The flexible electronic components have the advantages of being convenient and light. Because applications to mobile devices are more and more valued, the above advantages will be significant if the flexible components are applied to the mobile devices.

The flexible electronic component is generally formed by the integrated circuits being fabricated on a flexible substrate, but the process has its bottlenecks. The flexible substrate is usually required to be adhered temporarily onto a production stage during the production of the flexible electronic component, then the circuits are formed. After forming the circuits, the flexible electronic component needs to be removed from the production stage for subsequent processes. Since the flexible electronic component is too thin and light, the stress for overcoming the adhesion may cause damage to the flexible electronic component when removing the flexible electronic component, thereby affecting product yield.

Dry adhesion is an application of a biomimetic structure, and there is no residue after peeling off. The surface of the dry adhesion has a large number of micro-structures for generating an adsorption force, and its adhesive force is not reduced when re-using the dry adhesion. In the conventional process, these tiny structures are mostly formed by a lithography and etching process. First, photo resists and etching or the like are used to form the shapes of the tiny structures. Next, the tiny structures are filled with the molding material, and then the mold is cured and released. The mold has cavities complementary to the tiny structures. Next, the cavities are used to imprint and reproduce a large number of the tiny structures. However, lithography and etching processes are the more complex and time-consuming steps; when the design of the tiny structures is more complex, the process of exposure and development will be carried out more times. In addition, it is necessary to consider the yield of the cavities of the mold formed by the molding and releasing process.

It is therefore necessary to provide a biomimetic adhesive layer and a method of manufacturing the same to control the adhesive direction and adhesive force appropriately, and to simplify the manufacturing process in order to solve the problems existing in the conventional technology as described above.

### SUMMARY OF THE INVENTION

A primary object of the present invention is to provide a biomimetic adhesive layer and a method of manufacturing the biomimetic adhesive layer. The biomimetic adhesive layer comprises permeance particles capable of being magnetized or attracted by magnetic force so as to change the adhesive direction of the biomimetic layer, and further control the adhesive force. It therefore controls the adhesive direction and force of the biomimetic adhesive layer without using complicated molds. In addition, the structural strength of the biomimetic adhesive layer can be improved by the added permeance particles.

A secondary object of the present invention is to provide a method of manufacturing a biomimetic adhesive layer with a metallic mold having filling apertures for forming the biomimetic adhesive layer. Since the metallic mold has benefits from being directly processed, it can be produced without the lithography process and the mold filing process. The manufacturing process of the mold can be simplified and has the advantage in mass production. The production cost of the biomimetic adhesive layer can be reduced.

To achieve the above objects, the present invention provides a biomimetic adhesive layer comprising a plurality of protrusions, wherein each of the protrusions has a bottom surface and an upper surface; and a support portion connected with the bottom surface; wherein the protrusions are formed by a polymeric material mixed with permeance particles.

In one embodiment of the present invention, an area of the bottom surface is larger than an area of the upper surface.

In one embodiment of the present invention, each of the protrusions is shaped as a funnel and has a minimum external diameter.

In one embodiment of the present invention, the protrusions are columnar.

In one embodiment of the present invention, the area of the bottom surface is essentially equal to the area of the upper surface.

In one embodiment of the present invention, the minimum external diameter is smaller than an external diameter of the upper surface.

In one embodiment of the present invention, the minimum external diameter is ranged from 3 to 30 microns (μm).

In one embodiment of the present invention, the bottom surface is not parallel with the upper surface.

In one embodiment of the present invention, the upper surfaces are parallel with each other.

In one embodiment of the present invention, the upper surface is not parallel with the bottom surface in parts of the protrusions.

In one embodiment of the present invention, the upper surfaces of the parts of the protrusions are not parallel with the upper surfaces of other ports of the protrusions.

In one embodiment of the present invention, the polymeric material comprises thermoplastic polymers or photosensitive polymers.

In one embodiment of the present invention, the permeance particles are iron oxides, nickel aluminum alloys, chromium iron alloys, iron chromium molybdenum alloys, iron aluminum carbon alloys, iron cobalt alloys, manganese aluminum carbon alloys, or nickel iron alloys.

The present invention further provides a method of manufacturing a biomimetic adhesive layer, comprising steps of (1) providing a metallic mold having a plurality of filling apertures; (2) compressing a polymer substrate with the metallic mold to fill the polymer substrate within the filing apertures; (3) curing the polymer substrate; and (4) separating the metallic mold from the polymer substrate to obtain the biomimetic adhesive layer.

In one embodiment of the present invention, the polymer substrate is formed by a polymeric material mixed with permeance particles.

In one embodiment of the present invention, the polymeric material comprises thermoplastic polymers or photosensitive polymers.

In one embodiment of the present invention, the permeance particles are iron oxides, nickel aluminum alloys, chromium iron alloys, iron chromium molybdenum alloys, iron aluminum carbon alloys, iron cobalt alloys, manganese aluminum carbon alloys, or nickel iron alloys.

In one embodiment of the present invention, the method further comprises a step after the step (4): (5) adjusting an adhesive direction of the biomimetic adhesive layer.

In one embodiment of the present invention, the step (5) is performed by attracting the permeance particles by magnetic force so that the adhesive direction is changed from a forward direction to a side direction.

In one embodiment of the present invention, the step (1) comprises sub-steps of performing micro electrical discharge machining on a metal plate to form a plurality of via holes; and plating the via holes to form the filing apertures.

In one embodiment of the present invention, each of the filing apertures has two openings and one channel.

In one embodiment of the present invention, the channel is shaped as a funnel, and has a minimum internal diameter smaller than internal diameters of the openings.

In one embodiment of the present invention, the minimum internal diameter is ranged from 3 to 30 microns (μm).

In one embodiment of the present invention, the step (3) further comprises a step of heating to soften the polymer substrate.

In one embodiment of the present invention, the polymer substrate is heated to a temperature above 120° C.

In one embodiment of the present invention, the step (3) is performed by cooling to cure the polymer substrate.

In one embodiment of the present invention, the step (3) is performed by irradiating to cure the polymer substrate.

In one embodiment of the present invention, when compressing the polymer substrate with the metallic mold, the metallic mold is pressed by using a plate.

In one embodiment of the present invention, the biomimetic adhesive layer comprises a plurality of protrusions, wherein each of the protrusions has a bottom surface and an upper surface; and a support portion connected with the bottom surface; wherein the protrusions are formed on one surface of the polymer substrate.

In one embodiment of the present invention, the protrusions are formed at positions corresponding to the filing apertures.

### DESCRIPTION OF THE DRAWINGS

FIG. 1 is a schematic view of a biomimetic adhesive layer according to one embodiment of the present invention.

FIG. 2 is a schematic view of a biomimetic adhesive layer according to another embodiment of the present invention.

FIGS. 3a to 3e are flow charts of a method for manufacturing a biomimetic adhesive layer according to one embodiment of the present invention.

FIGS. 4a to 4b show the steps for providing a metallic mold in the method of manufacturing a biomimetic adhesive layer according to one embodiment of the present invention.

FIG. 5 is a partially cross-sectional view taken from a scanning electron microscope (SEM) showing the metallic mold according to one embodiment of the present invention (5 kV, by 400×).

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings. If there is no specific description in the invention, singular terms such as “a”, “one”, and “the” include the plural number. For example, “a compound” or “at least one compound” may include a plurality of compounds or the mixtures thereof. If there is no specific description in the invention, the “%” means “weight percent (wt %)”, and the numerical range (e.g. 10%˜11% of A) contains the upper and lower limit (i.e. 10%≦A≦11%). If the lower limit is not defined in the range (e.g. less than, or below 0.2% of B), it means that the lower limit is 0 (i.e. 0%≦B≦0.2%). The proportion of “weight percent” of each component can be replaced by the proportion of “weight portion” thereof. The abovementioned terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings allow ease of understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It should be understood that when an element such as a layer, film, region, or substrate is referred to as being “on” another element, it can be directly on the other element or intervening elements may also be present.

It should be understood that when an element such as a layer, film, region, or substrate is referred to as being “on” another element or “to” another element, it can be directly on the other element or intervening elements may also be present. On the contrary, when an element is referred to as being “directly on” another element, or “directly to” another element, there is no intervening element between one another. Furthermore, when an element is referred to as being “connected” or “coupled” to another element, it can be directly connected or coupled to the other element or intervening elements may also be present. On the contrary, when an element is referred to as being “directly connected to” or “directly coupled to” another element, there is no intervening element between one another.

In addition, in the specification, unless explicitly described to the contrary, the words “comprising”, “including”, “having”, and variations such as “comprises” or “comprising” will be understood to imply the inclusion of stated features, entirety, steps, operations, elements, components, and/or their combinations, but not the exclusion thereof.

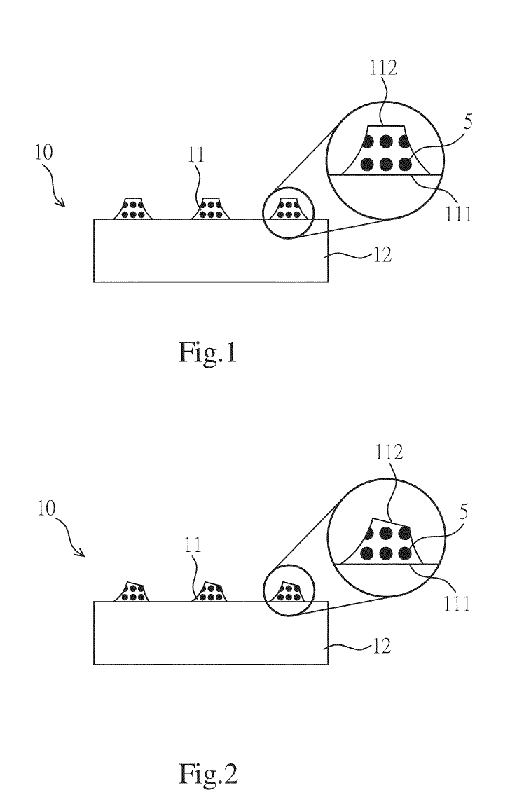

Refer to FIG. 1, a biomimetic adhesive layer 10 according to one embodiment of the present invention comprises a plurality of protrusions 11; and a support portion 12 disposed under the protrusions 11. Each of the protrusions 11 has a bottom surface 111 and an upper surface 112. The support portion 12 is connected with the bottom surface 111 of each of the protrusions 11. That is, the protrusions 11 can be integrated with the support portion 12, or formed in combination with a surface of the support portion 12. The protrusions 11 are formed by a polymeric material mixed with permeance particles. The area of the bottom surface 111 can be larger than the area of the upper surface 112. The protrusions 11 can be shaped as a funnel or a taper, and have a minimum external diameter smaller than the external diameter of the upper surface 112. The minimum external diameter is ranged from 3 to 30 microns, for example 10, 15, 22, 25 or 28 microns, but it is not limited thereto. In addition, when the protrusions 11 are integrated to the surface of the support portion 12, the protrusions 11 and the support portion 12 can be made from the same material.

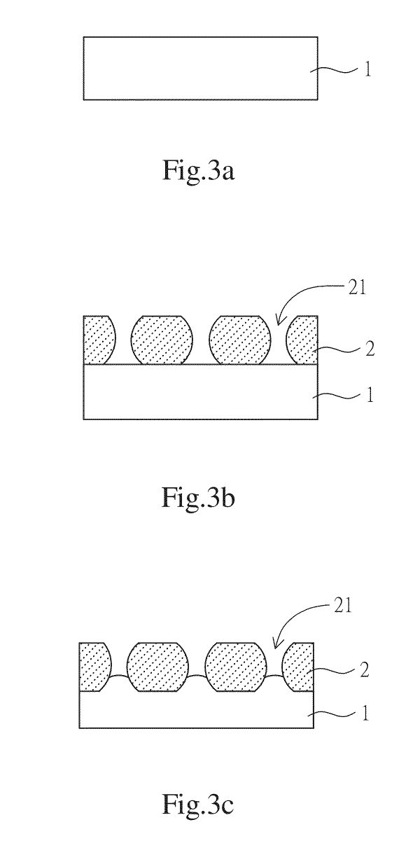

Refer to FIG. 2, which is a schematic view of a biomimetic adhesive layer 10 according to another embodiment of the present invention. In this embodiment, permeance particles 5 can be attracted by magnetic force or magnetized, so that the permeance particles 5 in the protrusions 11 can be attracted by using magnetic force. When the permeance particles 5 in the protrusions 11 are attracted by the magnetic force, the polymeric material of the protrusions 11 may move or deform slightly. Therefore, the upper surface 112 of each of the protrusions 11 can be adjusted according to the requirements when used in practice; for example, the facing direction of the upper surface 112 is changed from a forward direction to a side direction (as shown in FIG. 1) so that the total adhesive force of the biomimetic adhesive layer 10 can further be controlled. In the meanwhile, the upper surface 112 faces to the side direction so that the bottom surface 111 and the upper surface 112 are not parallel with each other. Furthermore, several upper surfaces 112 are substantially parallel with each other no matter whether the upper surface 112 faces the forward direction or the side direction.

In one embodiment, a part of the protrusions 11 can be controlled to deform by using the permeance particles capable of being attracted by magnetic force or magnetized, so that the upper surface 112 of the protrusion is not parallel with the bottom surface 111 of the same protrusion within the part (region) of the protrusions 11, and the upper surface 112 which belongs to the protrusion in the part of the protrusions 11 is not parallel with the upper surface 112 which belongs to the protrusion in the other part of the protrusions 11.

Furthermore, in the biomimetic adhesive layer 10 according to this embodiment, the polymeric material can be thermoplastic polymers or photosensitive polymers. The permeance particles are iron oxides, nickel aluminum alloys, chromium iron alloys, iron chromium molybdenum alloys, iron aluminum carbon alloys, iron cobalt alloys, manganese aluminum carbon alloys, or nickel iron alloys.

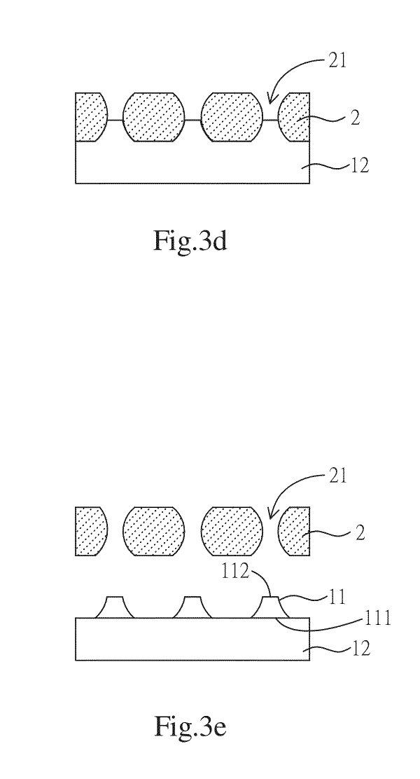

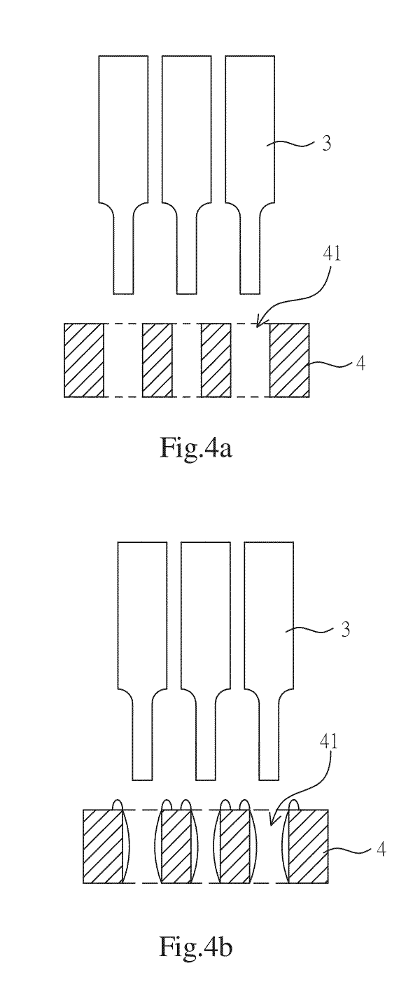

Refer to FIGS. 3a to 3e, a method of manufacturing a biomimetic adhesive layer according to one embodiment of the present invention comprises steps of: providing a polymer substrate 1; providing a metallic mold 2 having a plurality of filing apertures 21; compressing the metallic mold 2 and the polymer substrate 1 to fill the polymer substrate within the filing apertures; curing the polymer substrate 1; and separating the metallic mold 2 from the polymer substrate 1 to obtain a biomimetic adhesive layer. The principle and the implementation details of each step in the third embodiment of the present invention will be described in detail hereinafter with reference to FIGS. 3a to 3e and FIGS. 4a to 4c.

First, refer to FIG. 3a, the method of manufacturing a biomimetic adhesive layer according to one embodiment of the present invention is the step of providing a polymer substrate 1. In this step, the polymeric material can be thermoplastic polymers, or photosensitive polymers. The permeance particles are iron oxides, nickel aluminum alloys, chromium iron alloys, iron chromium molybdenum alloys, iron aluminum carbon alloys, iron cobalt alloys, manganese aluminum carbon alloys, or nickel iron alloys.

Next, refer to FIG. 3b, the method of manufacturing a biomimetic adhesive layer according to one embodiment of the present invention is the step of providing a metallic mold 2 having a plurality of filing apertures 21. In this step, each of the filing apertures 21 has two openings and one channel. The channel is shaped as a funnel, and has a minimum internal diameter smaller than internal diameters of the openings. The minimum internal diameter is ranged from 3 to 30 microns (μm), for example 10, 22, 25, or 28 microns, but it is not limited thereto.

Next, refer to FIG. 3c, the method of manufacturing a biomimetic adhesive layer according to one embodiment of the present invention is the step of compressing the metallic mold 2 and the polymer substrate 1 to fill the polymer substrate 1 within the filing apertures 21. In this step, if the polymer substrate 1 comprises thermoplastic polymers, the polymer substrate 1 can be heated, for example to a temperature above 120° C., so that the polymer substrate 1 can be softened, and then the filing apertures 21 of the metallic mold 2 are filled with a part of the softened polymer substrate 1; if the polymer substrate 1 comprises photosensitive polymers, such as photo resists, the polymer substrate 1 may not be heated. In addition, when compressing the metallic mold 2 and the polymer substrate 1, an appropriate pressure can be applied to the polymer substrate 1 and the metallic mold 2 so that the metallic mold 2 is embedded slightly into the upper surface of the polymer substrate 1 to fill the filing apertures 21 of the metallic mold 2 with a little part of the polymer substrate 1. Furthermore, a plate (e.g. polymer plate or metallic plate) can be used for providing the pressure to the metallic mold 2 when compressing the metallic mold 2 and the polymer substrate 1 so that the metallic mold 2 is embedded slightly into the upper surface of the polymer substrate 1.

Next, refer to FIG. 3d, the method of manufacturing a biomimetic adhesive layer according to one embodiment of the present invention is the step of curing the polymer substrate 1. In this step, if the polymer substrate comprises photosensitive polymers, the polymer substrate 1 can be cured by irradiation, for example; if the polymer substrate comprises thermoplastic polymers, the polymer substrate 1 can be cured by cooling. The way for curing the polymer substrate 1 is determined by the curing properties of the selected polymer material.

Next, refer to FIG. 3e, the method of manufacturing a biomimetic adhesive layer according to one embodiment of the present invention is the step of separating the metallic mold 2 from the polymer substrate 1 to obtain a biomimetic adhesive layer 10. In this step, the biomimetic adhesive layer 10 comprises a plurality of protrusions 11, wherein each of the protrusions 11 has a bottom surface 111 and an upper surface 112; and a support portion 12 connected with the bottom surface 111 of each of the protrusions 11; wherein the protrusions 11 are formed on a surface of the polymer substrate 1. The protrusions 11 are formed at positions corresponding with the filing apertures 21. It should be understand that the shapes of the filing apertures 21 correspond with the shapes of the protrusions 11. In the meanwhile, the protrusions 11 formed in accordance with the third embodiment are integrated to the support portion 12. At this time, the protrusions 11 and the support portion 12 can be made from the same material. For completely separating the polymer substrate 1 from the metallic mold 2, the metallic mold 2 is preferably made from nickel cobalt alloys, nickel palladium alloys, aluminum, or stainless steels (alloy steels or tool steels) to prevent the polymer substrate 1 from leaving residues in the metallic mold 2 that cause structural damage to the protrusions 11.

Furthermore, in one embodiment, alternatively, if the polymer substrate comprises the permeance particles, the adhesive direction of the biomimetic adhesive layer 10 can be adjusted after the biomimetic adhesive layer is obtained. When adjusting the adhesive direction of the biomimetic adhesive layer 10, the face direction of the upper surface 112 or the shape of the protrusions 11 can be modified by attracting the permeance particles with magnetic force or magnetizing the permeance particles, so as to change the adhesive direction of the biomimetic adhesive layer from a forward direction to a side direction. Therefore, refer back to FIG. 2, the upper surface 112 faces to the side direction so that the bottom surface 111 and the upper surface 112 are not parallel with each other. Furthermore, the upper surface 112 in each of the protrusions 11 is substantially parallel with another upper surface no matter whether the upper surface 112 faces the forward direction or the side direction.

Moreover, in a method of manufacturing a biomimetic adhesive layer according to one embodiment, a part of the protrusions 11 can be controlled to deform by using the permeance particles capable of being attracted by magnetic force or magnetized, so that the upper surface 112 of the protrusion is not parallel with the bottom surface 111 of the same protrusion within the part (region) of the protrusions 11, and the upper surface 112 which belongs to the protrusion in the part of the protrusions 11 is not parallel with the upper surface 112 which belongs to the protrusion in other part of the protrusions 11.

Refer to FIGS. 4a to 4b, when providing the metallic mold 2, the method of manufacturing a biomimetic adhesive layer according to one embodiment of the present invention further comprises steps of performing micro electrical discharge machining on a metal plate 4 to form a plurality of via holes 41; and plating the via holes 41 to form the filing apertures 21. In FIG. 4a, array electrodes 3 can be formed with preferred sizes by wire electrical discharge grinding (WEDG), micromachining, or etching with photo resists and then plating. Next, micro electrical discharge machining (μ-EDM) is performed on the metal plate 4 by using the array electrodes 3 to drill the via holes 41. Next, as shown in FIG. 4b, after the array electrodes 3 are fined by WEDG again, the array electrodes are placed in the via holes 41, and then metallic depositions are formed on specific portions of the via holes 41 by plating, thereby the metallic mold 2 having the plurality of filing apertures 21 can be formed.

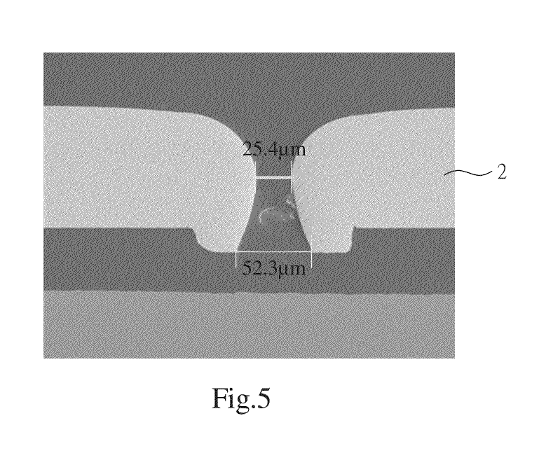

FIG. 5 shows a partially cross-sectional view of the metallic mold formed according to one embodiment of the present invention, taken from a scanning electron microscope (SEM). One of the filing apertures 21 of the metallic mold 2 has the minimum internal diameter about 25.4 microns.

Compared with conventional techniques, a biomimetic adhesive layer according to the present invention comprises permeance particles capable of being magnetized or attracted by magnetic force so as to change the adhesive direction of the biomimetic layer, and further control the adhesive force. In addition, the structural strength of the biomimetic adhesive layer can be improved by the added permeance particles. Furthermore, the present invention also provides a method of manufacturing a biomimetic adhesive layer with a metallic mold having benefits from being directly processed, so as to be produced without the lithography process and the mold filing process. The manufacturing process of the mold can be simplified, and thus has advantages of mass production and yield improvement. The production cost of the biomimetic adhesive layer can be reduced.

Moreover, methods within the scope of this disclosure may include more or fewer steps than those described.

The phrases “in some embodiments” and “in various embodiments” are used repeatedly. These phrases generally do not refer to the same embodiments; however, they may. The terms “comprising”, “having”, and “including” are synonymous, unless the context dictates otherwise.

Although various example methods, apparatuses, and systems have been described herein, the scope of coverage of the present disclosure is not limited thereto. On the contrary, the present disclosure covers all methods, apparatus, systems, and articles of manufacture fairly falling within the scope of the appended claims, which are to be construed in accordance with established doctrines of claim interpretation. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

The present invention has been described with preferred embodiments thereof and it is understood that many changes and modifications to the described embodiments can be carried out without departing from the scope and the spirit of the invention that is intended to be limited only by the appended claims.

What is claimed is:

1. A biomimetic adhesive layer, comprising:
a plurality of protrusions, wherein each of the protrusions has a bottom surface and an upper surface; and
a support portion connected with the bottom surface;
wherein the protrusions are formed by a polymeric material mixed with permeance particles.

2. The biomimetic adhesive layer according to claim 1, wherein an area of the bottom surface is larger than an area of the upper surface.

3. The biomimetic adhesive layer according to claim 1, wherein each of the protrusions is shaped as a funnel and has a minimum external diameter.

4. The biomimetic adhesive layer according to claim 3, wherein the minimum external diameter is smaller than an external diameter of the upper surface.

5. The biomimetic adhesive layer according to claim 3, wherein the minimum external diameter is ranged from 3 to 30 microns.

6. The biomimetic adhesive layer according to claim 1, wherein the bottom surface is not parallel with the upper surface.

7. The biomimetic adhesive layer according to claim 1, wherein the upper surfaces are parallel with each other.

8. The biomimetic adhesive layer according to claim 1, wherein the polymeric material comprises thermoplastic polymers or photosensitive polymers.

9. The biomimetic adhesive layer according to claim 1, wherein the permeance particles are iron oxides, nickel aluminum alloys, chromium iron alloys, iron chromium molybdenum alloys, iron aluminum carbon alloys, iron cobalt alloys, manganese aluminum carbon alloys, or nickel iron alloys.

10. A method of manufacturing a biomimetic adhesive layer, comprising steps of:
(1) providing a metallic mold having a plurality of filling apertures;
(2) compressing a polymer substrate with the metallic mold to fill the polymer substrate within the filing apertures;
(3) curing the polymer substrate; and
(4) separating the metallic mold from the polymer substrate to obtain the biomimetic adhesive layer.

11. The method according to claim 10, wherein the polymer substrate is formed by a polymeric material mixed with permeance particles.

12. The method according to claim 11, wherein the polymeric material comprises thermoplastic polymers or photosensitive polymers.

13. The method according to claim 11, wherein the permeance particles are iron oxides, nickel aluminum alloys, chromium iron alloys, iron chromium molybdenum alloys, iron aluminum carbon alloys, iron cobalt alloys, manganese aluminum carbon alloys, or nickel iron alloys.

14. The method according to claim 11, wherein the method further comprises a step after the step (4):
(5) adjusting an adhesive direction of the biomimetic adhesive layer.

15. The method according to claim 14, wherein the step (5) is performed by attracting the permeance particles with magnetic force so that the adhesive direction is changed from a forward direction to a side direction.

16. The method according to claim 10, wherein the step (1) comprises sub-steps of:
performing micro electrical discharge machining on a metal plate to form a plurality of via holes; and
plating the via holes to form the filing apertures.

17. The method according to claim 10, wherein each of the filing apertures has two openings and one channel.

18. The method according to claim 17, wherein the channel is shaped as a funnel, and has a minimum internal diameter smaller than internal diameters of the openings.

19. The method according to claim 18, wherein the minimum internal diameter is ranged from 3 to 30 microns.

20. The method according to claim 10, wherein the step (2) further comprises a step of heating to soften the polymer substrate.

21. The method according to claim 20, wherein the step (3) is performed by cooling to cure the polymer substrate.

22. The method according to claim 10, wherein the step (3) is performed by irradiating to cure the polymer substrate.

23. The method according to claim 10, wherein the biomimetic adhesive layer comprises a plurality of protrusions, wherein each of the protrusions has a bottom surface and an upper surface; and a support portion connected with the bottom surface;
wherein the protrusions are formed on one surface of the polymer substrate.

24. The method according to claim 23, wherein the protrusions are formed at positions corresponding with the filing apertures.
